(19) United States
(12) Patent Application Publication
(10) Pub. No.: US 2003/0169208 A1
(43) Pub. Date: Sep. 11, 2003

(54) Positioning structure of inner coil for antenna

(75) Inventor: Tony Wu, Pa-Te City (TW)

Correspondence Address: BRUCE H. TROXELL, SUITE 1404, 5205 LEESBURG PIKE, FALLS CHURCH, VA, 22041, US

(73) Assignee: Auden Techno Corp.

(21) Appl. No.: 10/093,520

(22) Filed: Mar. 11, 2002

(51) Int. Cl. H01Q 1/36

(52) U.S. Cl. 343/895; 343/702; 343/900

(57) ABSTRACT

An improved positioning structure of an inner coil for an antenna, wherein: an inner coil with a predetermined length and shape of the antenna is provided on the bottom thereof with a metallic receiving seat for placing in a die to be injected therein plastic material. The inner coil and the injection material have a downwardly extending shaping hole with a predetermined depth provided at the center of a top surface on the top thereof, in order to prevent the inner coil from deformation by injecting the plastic material in the die during injection shaping. The metallic receiving seat is further provided on the bottom thereof with an axial hole which is convenient for taking the product out of the die in a stable state in mass production.

### BACKGROUND OF THE INVENTION

1. Field of the Invention

The present invention is related to an improved positioning structure of an inner coil for an antenna; and especially to such a structure by which the coil in the antenna can be shaped in a stable state helpful to taking off from a die after processing.

2. Description of the Prior Art

A helical coil made from a winding metallic strip is the main element of an antenna used for signal receiving and emitting. Such a helix antenna structure can affect in all aspects the functions of the antenna. For example, in a helix antenna in a British patent No. 2,206,243, the core diameter of the helix made of material such as copper plated steel, the pitch of helix, the over all length etc. all affect the set proper functions of the antenna.

In a mobile phone using such material of wire as an example, generally, a helix coil is placed in an inner hole of an insulating external sleeve of the body of the mobile phone in an elastically compressed state. By the nature of the helix coil, such an assembling structure will have unexpected influence on the pitch of helix and the over all length; that is, a trouble that the pitch of helix of the coil after assembling may be changed and the over all length after assembling may be different from the original one is probably induced. When in mass production of the conventional helix coil with such an assembling structure, it may have the phenomenon that qualities of the products are different from day to day.

And more, antennas with such helix coils do not only use a single frequency, for example, in a Japanese patent 1997-320748, a coil provided in an external sleeve thereof can have its consonant frequency decided by the length of extending of an adjusting member extending from the outside of the external sleeve into the coil. By all means, the consonant frequency can also depend on the factors of the diameter, the material, the pitch of helix and length etc. If the factors can no be surely controlled, it is very hard to acquire the consonant frequency desired.

And sometimes mobile phones used nowadays have more than one frequency, such as two frequencies including 900 KHZ and 1800 KHZ, there have been various methods and structures used for making such a dual-frequency antenna, such as in the above stated British patent No. 2,206,243, an elongate coil and a linear conductor extending into the coil are used to form the dual-frequency helical antenna. In a recent case, a single coil with a dense and a loose section is used for getting two frequencies. As is shown in a drawing of the application, such a coil has a denser winding section (with a shorter pitch of helix) and a looser winding section (with a longer pitch of helix) are included in the over all length to get the two frequencies desired. Keeping of the different pitches of helix of such a coil is quite important, while the assembling structure of the conventional helix coil is subjected to elastically compressing the coil and destroying the set pitch of helix as well as the length and thereby influences the proper function of the coil.

Using a mode of positioning of an inner coil can slow down the rate of production; however, it has an effect of making precision of the inner coil interiorly. Such a inner coil for an antenna now available is shown in FIG. 1, wherein, the coil 11 and a metallic receiving seat 10 on the bottom end thereof are placed in a die (referring to step A), then the coil 11 is injected therein plastic material 12 (referring to step B), a housing 13 is injection formed to envelop this semi-finished article (referring to step C). Such processing mode still can influence the configuration of the coil 11 during injection molding of the plastic material 12 in the die; and it is more troublesome and inconvenient to take out the shaped product.

### SUMMARY OF THE INVENTION

The object of the present invention is to provide an improved positioning structure of an inner coil for an antenna, wherein, a shaping hole is provided on the top end of the injection material in the coil for positioning, in order that during injection molding, the configuration of the coil can be more precisely positioned. Meantime, the metallic receiving seat of the coil placed in the die is provided with an axial hole which is convenient for taking the product out of the die in mass production.

The present invention will be apparent in its novelty and other features after reading the detailed description of the preferred embodiment thereof in reference to the accompanying drawings.

### BRIEF DESCRIPTION OF THE DRAWINGS

FIG. 1 is a flow diagram showing the steps of processing in positioning a conventional coil interiorly;

FIG. 2 is a perspective view showing a preferred embodiment of the present invention;

FIG. 3 is a front view taken from FIG. 2;

FIG. 4 is a sectional view taken from FIG. 2;

FIG. 5 is a schematic view showing shaping of the present invention in the die.

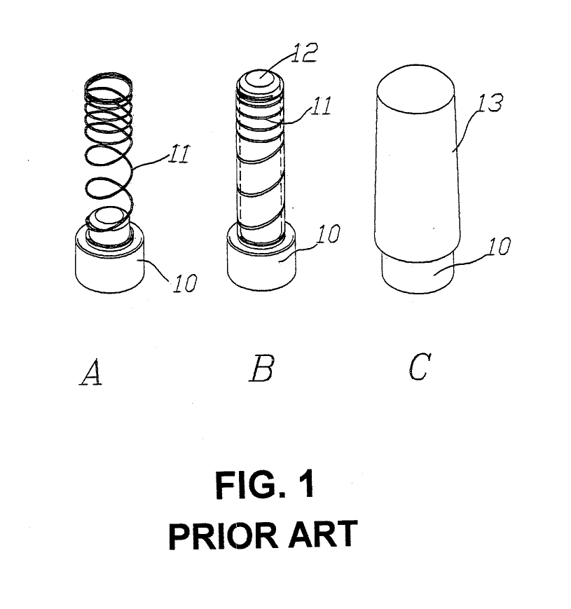

### DETAILED DESCRIPTION OF THE PREFERRED EMBODIMENT

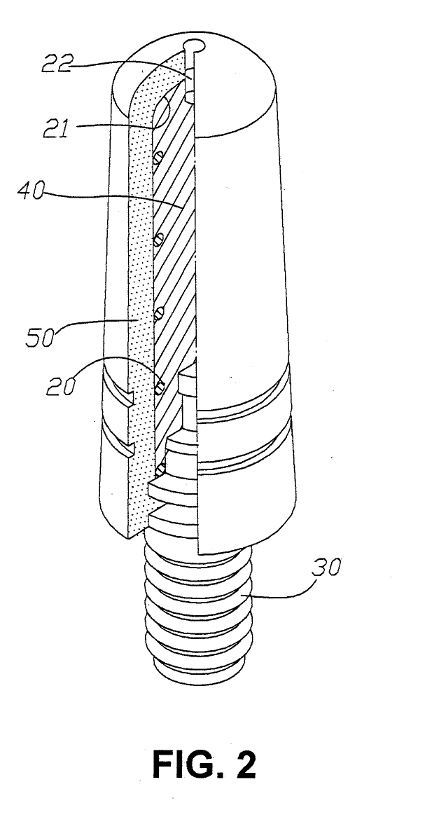

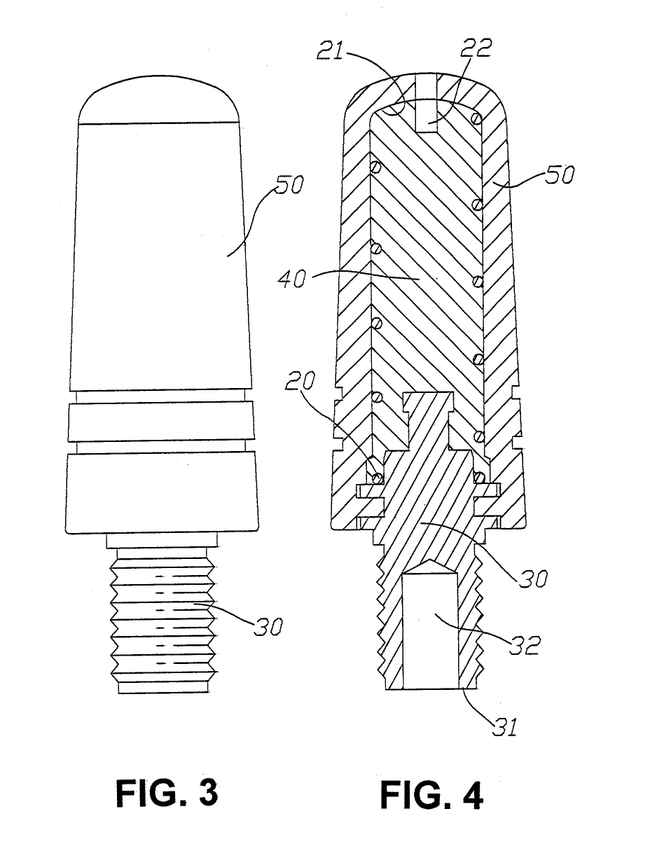

Referring to FIGS. 2-4, the antenna of the present invention is also comprised of an inner coil 20, a metallic receiving seat 30, plastic material 40 for injecting into the inner coil 20, and a housing 50 injection enveloping the abovementioned elements. In which, the inner coil 20 and the metallic receiving seat 30 are similarly placed in a die for injection shaping of the plastic material 40.

The present invention is characterized by that, a downwardly recessed shaping hole 22 with a predetermined depth is provided at the center of a top surface 21 on the top of the inner coil 20 and the plastic material 40. Taking this antenna with an over all length of 25 mm as an example, when the diameter of the plastic material 40 is about 5.4 mm, the shaping hole 22 had better have a diameter 1 mm, while the recessed depth is 2 mm.

The bottom end 31 of the metallic receiving seat 30 is provided with an axial hole 32 extending upwardly. In the embodiment shown, when the exposed length of the metallic receiving seat 30 is 7.2 mm, and the diameter thereof is 5.5 mm, the diameter of the axial hole 32 can be 2.8 mm, and the depth of the axial hole 32 is most preferably about 5 mm.

By the fact that the shaped inner coil 20 is positioned between the plastic material 40 and the housing 50, the upper shaping hole 22 and the lower axial hole 32 both will not be influential on the shaped inner coil 20.

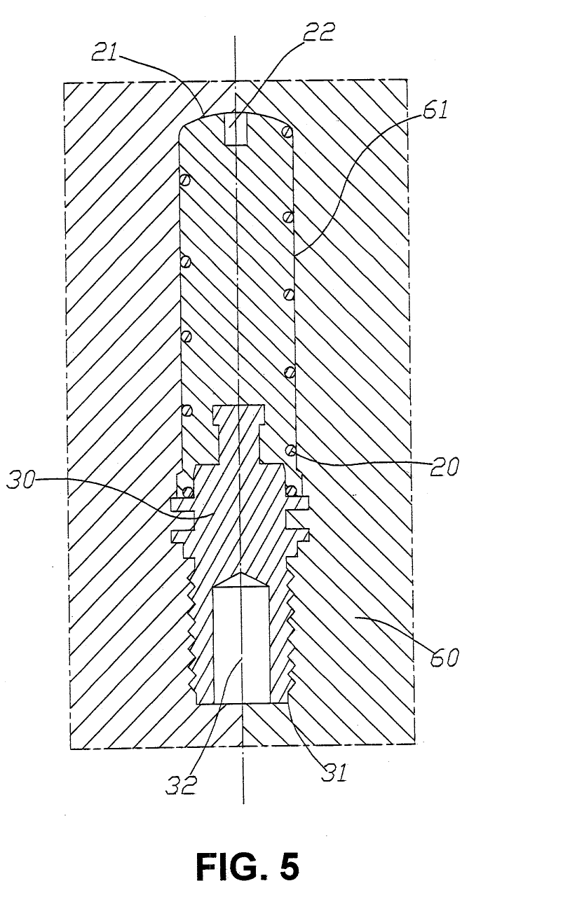

Referring to FIG. 5, the area 60 shown with oblique lines is exactly the scope of enveloping; in an ideal experiment, the material injecting point 61 had better be located at one side and above the metallic receiving seat 30. More preferably, the injecting point 61 is enlarged. In shaping an antenna with the above described size, the injecting point 61 can be 5 mm long and 0.3 mm wide. Increasing the width of the injecting point 61 can have the advantage of preventing strong injecting in the small path from deforming the inner coil 20.

Again as shown in FIG. 5, in addition to have the injecting point 61 enlarged, the present invention can further prevent the inner coil 20 from probable deformation (that may have its originally set function and modeling lost) by injecting the plastic material 40 during injection shaping taking the upper shaping hole 22 as a support point by extending a top pin therein (not shown). And after injection of material, the lower axial hole 32 can allow extending in of another top pin to help fast and stably taking a product out of the die.

In the present invention, the primary inner coil of the antenna is shaped and assembled in a more precise way, so that quality of the antenna is more stable, reliable as well as fine. It is convenient for taking out the articles in mass production, and thereby is industrially valuable.

The above stated preferred embodiment is only for illustrating the present invention. It will be apparent to those skilled in this art that various modifications or changes can be made to the present invention. And all such modifications and changes without departing from the spirit of this invention also fall within the scope of the appended claims and are intended to form part of this invention.

1. An improved positioning structure of an inner coil for an antenna, wherein:
an inner coil with a predetermined length and shape of said antenna is provided on the bottom thereof with a metallic receiving seat for placing in a die to be injected therein plastic material, and then a housing is injection formed for enveloping, said structure is characterized by that, a shaping hole with a predetermined depth is provided at the center of a top surface on the top of said inner coil and said plastic material, so that said coil is positioned during injection to prevent it from deformation.

2. The structure as claimed in claim 1, wherein,
said metallic receiving seat is provided on the bottom thereof with an axial hole extending inwardly for a predetermined length.

3. The structure as claimed in claim 1 or claim 2, wherein,
a material injecting point on said die is located at one side and above said metallic receiving seat and is enlarged in width.
